(19) United States
(12) Patent Application Publication
(10) Pub. No.: US 2005/0271096 A1
(43) Pub. Date: Dec. 8, 2005

(54) Laser output temperature compensation

(76) Inventors: Rolland Zeleny, Sharon, MA (US); Clifford E. Morrow, North Kingston, RI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/103,858

(22) Filed: Apr. 12, 2005

Related U.S. Application Data
(60) Provisional application No. 60/561,328, filed on Apr. 12, 2004.

(51) Int. Cl. H01S 3/13; H01S 3/04

(52) U.S. Cl. 372/29.011; 372/34

(57) ABSTRACT

A method according to one embodiment includes measuring a temperature of a laser tube. The method may also include generating a feedback signal indicative of the temperature of the laser tube. The method may also include adjusting a power supplied to the laser tube based on, at least in part, the feedback signal. Of course, many alternatives, variations, and modifications are possible without departing from this embodiment.

This application claims the benefit of U.S. Provisional Application Ser. No. 60/561,328, filed Apr. 12, 2004.

### FIELD

The present disclosure relates generally to laser systems, and more particularly to a control system for a laser.

### BACKGROUND

The performance of a laser may generally be inversely related to the temperature of the laser tube. Accordingly, the performance of a laser may decrease as the temperature of the laser tube increases. An increase in temperature giving rise to the decrease in the performance of the laser may occur for a number of reasons. For example, operation of the laser may itself cause the laser tube to heat up. As the temperature of the laser tube increases, the power output of the laser may correspondingly decrease for a given driving power to the laser. Changes in the ambient temperature, for example of a manufacturing facility, during the course of a day, or other time period, may also result in changes in the laser power output for a given driving power to the laser.

Many applications, for which lasers are employed, may require a controlled laser power output within a specific power range. For example, in a marking application, laser power within a defined operating window may achieve effective results. However, an increase in laser power above the operating window may result in damage to the package or article being marked. Similarly, a decrease in power below the operating window may provide insufficient power to achieved full marking. In such a situation marking generated by the laser may be faint, incomplete, or completely unachieved.

Accordingly, in many applications, shifts in laser power output resulting from temperature changes may lead to inconsistent results or worse. For this reason it may be necessary to measure the laser power output frequently and to recalibrate the laser system so that a desired laser output may be maintained. Recalibration processes however may require, for example, stopping a manufacturing line while the laser is being recalibrated. Delays such as this may be disruptive and reduce productivity.

### BRIEF DESCRIPTION OF THE DRAWINGS

Features and advantages of embodiments of the disclosed subject matter will be apparent from the following description of such embodiments, which description should be considered in conjunction with the accompanying drawings, wherein:

FIG. 1 schematically illustrates an embodiment of a laser system;

FIG. 2 illustrates an embodiment of a compensation system;

FIG. 3 illustrates another embodiment of a compensation system;

FIG. 4 illustrates yet another embodiment of a compensation system; and

FIG. 5 illustrates still a further embodiment of a power output compensation system consistent with the present disclosure.

### DETAILED DESCRIPTION OF EXEMPLARY EMBODIMENTS

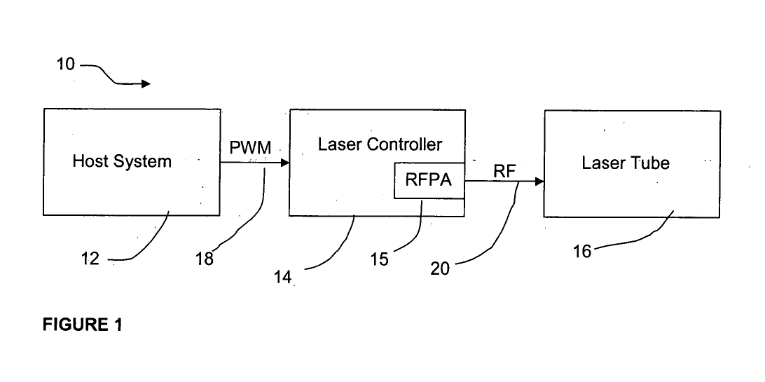

Referring to FIG. 1, a laser system 10 is schematically illustrated. The laser system may generally include a host system 12, a laser controller 14, and a laser tube 16. According to an embodiment, the laser system 10 may be an RF excited carbon dioxide laser system. In such an embodiment, the host system 12 may be a system or component that may provide a pulse-width-modulated (PWM) control signal 18 to the laser controller 14. The laser controller 14 may include an RF power amplifier 15 that may provide RF power 20 to the laser tube 16 according to the PWM control signal 18 from the host system. A laser system 10 as shown and described may be suitable for a wide variety of applications. For example, the laser system 10 may be suitably employed in a marking or coding system, etc.

As used in any embodiment of this disclosure, the host system 12 may be a system or component that provides a control signal that may affect the power output of the laser. Similarly, as used herein the laser controller 14 may be any system or component that produces an output to drive the laser tube in response to a control signal from the host system. The laser tube 16 may include core laser components required to produce light. For example, the laser tube 16 may include an optical resonator, a gain medium, and may further include a supporting frame to support the optical resonator and/or gain medium. The laser tube 16 may also include such features as electrodes to excite the gain medium, however, such features may vary for different varieties of lasers. FIG. 1 illustrates the host system 12, laser controller 14, and laser tube 16 as separate and discrete elements for the purpose of clarity and convenient explanation. One or more of the host system 12, laser controller 14, and laser tube 16 may be integrated and/or provided in a common package, enclosure, or system.

During operation, the laser tube 16 may increase in temperature. The increase in temperature may be a result of the operation of the laser, an increase in ambient temperature, insufficient cooling, etc. Such increases in temperature may be most pronounced on air cooled laser systems. As the temperature of the laser tube 16 increases, the laser tube 16 may exhibit laser power instability over temperature that may result in a decrease in the laser power output for a given power input signal. This laser output power instability over temperature may be expressed as POWER OUT=POWER REQUESTED×(1−(K×% change of temperature/100). Where K=a constant that defines the rate of power change with temperature and % change is relative to ambient temperature. The decrease in power output with increasing temperature may adversely affect the performance of the laser system. The relationship between power output and temperature may often be mapped to provide power output v. temperature plots for laser systems.

Consistent with the present disclosure, a temperature compensation system may be provided to prevent or mitigate a decrease in laser output power instability associated with a change in temperature. The system of the present disclosure may generally monitor a temperature of the laser tube, ambient air temperature, temperature of a cooling medium, etc. and provide a feedback loop to adjust an input to the laser tube to compensate for the change in output. It should be noted that while the description may generally refer to a loss of power associated with an increase in the temperature of the laser tube, a corresponding increase in power output may be realized as a result in a decrease in the temperature of the laser tube. In an application in which it is desirable to maintain a generally constant laser power output, the temperature compensation of the present disclosure may also be used to adjust an input to the laser tube to decrease the power output. A temperature compensation system consistent with the present disclosure may be provided as an original equipment component of a laser, or may be provided as an add-on or accessory to an existing laser system.

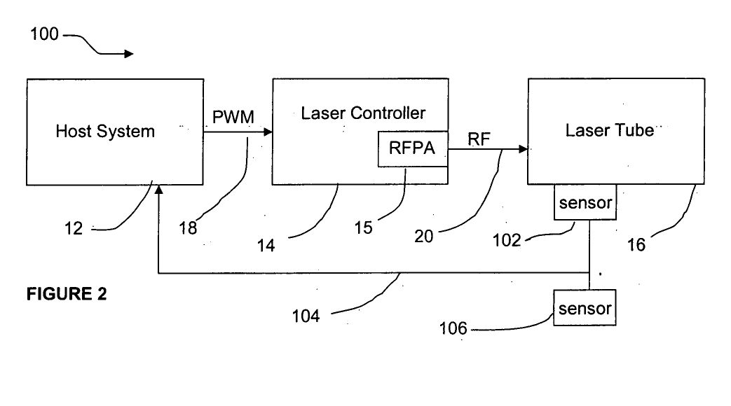

Turning to FIG. 2, one embodiment of a temperature compensation system 100 is schematically illustrated. The system 100 may include a temperature sensor 102 associated with the laser tube 16. The temperature sensor 102 may include any device or system configured to provide a signal that is indicative of, or proportional to, the temperature of the laser tube. The sensor 102 may vary with temperature in a known manner. For example, a temperature sensor may include a thermocouple, thermister, etc. The temperature sensor 102 may be coupled to the laser tube 16 allowing the temperature of the laser tube 16 to be measured. The temperature sensor 102 may be either directly or indirectly coupled to the laser tube 16. An embodiment in which the temperature sensor 102 is directly coupled to the laser tube 16 may include a thermocouple bonded to the laser tube 16 using a metal filled, thermally conducting, epoxy resin. Alternatively, a thermocouple may be strapped or mechanically fastened directly to the laser tube 16.

The temperature compensation system 100 may include a feedback loop 104 from the temperature sensor 102 to the host system 12. The feedback loop may provide temperature feedback information to the host system 12, which may operate to alter the PWM control signal 18 from the host system 12 to the laser controller 14. The RF power 20 from the laser controller 14 to the laser tube 16 may be correspondingly affected. For example, the feedback loop 104 may cause the duty cycle of the PWM control signal 18 to be increased in response to an increase in temperature sensed by the temperature sensor 102. The increase in duty cycle of the PWM control signal 18 may produce an increase in the RF power 20 to the laser tube 16. This may, in turn, increase the power output of the laser.

As discussed above, the power output instability of the laser may be known, such that, for example, a percentage decrease in power associated with a given increase in temperature is known and stored in table or formula form in the host system 12. The increase in the duty cycle of the PWM control signal 18 may be provided to produce a specific increase in the RF power 20 provided to the laser tube 16 from the laser controller 14, such that the resulting increase in laser power output may correspond to the decrease in power resulting from the increase in temperature. Accordingly, it may be possible to maintain a constant power output over temperature.

According to some embodiments, the system 100 may additionally, or alternatively, include a second temperature sensor 106. The second temperature sensor 106 may sense a temperature of a cooling medium associated with the laser tube or ambient air, etc., and provide an output corresponding to the sensed temperature. The second temperature sensor may operate in the feedback loop 104 with the first temperature sensor 102, for example, so that the feedback loop 104 adjusts the PWM control signal 18 based on a weighted sum of the temperatures sensed by the first 102 and second 106 temperature sensors, etc.

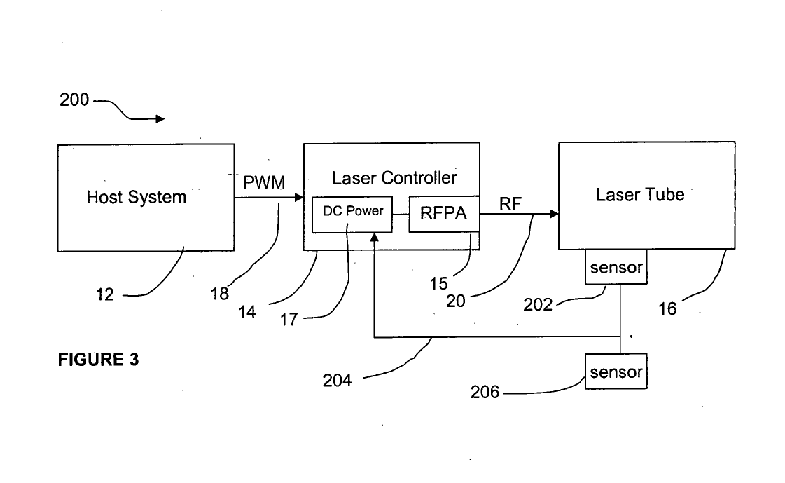

FIG. 3 illustrates another embodiment of a temperature compensation system 200. The temperature compensation system 200 may include a temperature sensor 202 directly or indirectly coupled to the laser tube 16. The temperature compensation system 200 may further include a feedback loop 204 to a supply of DC power 17 to the RF power amplifier 15 of the laser controller 14. The temperature compensation system 200 may adjust the DC power supply 17 which may operate to adjust the RF power amplifier 15, and thereby adjust the RF power 20 from the laser controller 14 to the laser tube 16. In this manner, the temperature compensation system 200 may adjust the power output of the laser.

The temperature compensation may additionally, or alternatively include a second temperature sensor 206 associated with a cooling medium, ambient atmosphere, etc. The second temperature sensor 206 may operate in conjunction with the first temperature sensor 202 to control the DC power 17 to the RF power amplifier 15 in response to a sensed temperature. The power output adjustment performed by the temperature compensation system 200 may, therefore be at least in part responsive to a sensed temperature of a cooling medium or ambient atmosphere.

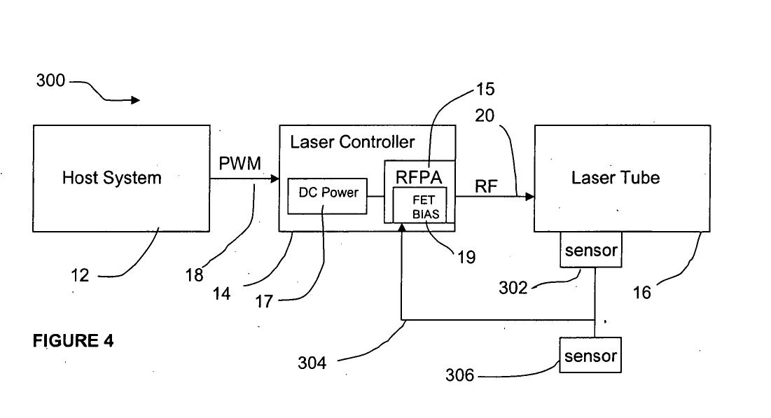

Turning to FIG. 4, another embodiment of a temperature compensation system 300 is shown. The temperature compensation system 300 may include a temperature sensor 302 directly or indirectly coupled to the laser tube 16. The temperature compensation system 300 may also include a feedback loop 304 to an RF power amplifier 15 of the laser controller 14. The feedback loop 304 may adjust the RF power 20 to the laser tube 16. In one embodiment, the feedback loop 304 may adjust the RF power 20 from the RF amplifier 15 by biasing the power FET (field effect transistor) 19 in the RF power amplifier 15. Accordingly, the RF power 20 to the laser tube 16 may be adjusted in response to the temperature sensed by the temperature sensor 302.

As previously described, the temperature compensation system 300 may include additional, or alternative, temperature sensors, e.g. 306, for controlling the bias on the FET 19 at least partially in response to the temperature sensed by the additional or alternative temperature sensors 306. In this embodiment the sensors 302 and 306 may include compensation means to overcome nonlinear effects or the signal 304 might be processed before directly connecting to the FET bias 19.

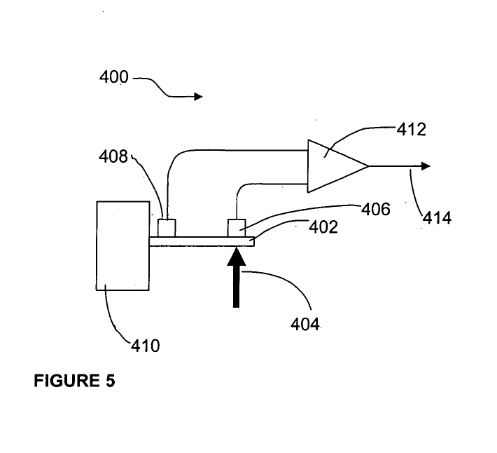

Consistent with another embodiment, a change in power output of a laser resulting from a change in temperature may be carried out based on a measured power output of the laser. Referring to FIG. 5, an embodiment of a thermal differential system 400 for measuring the power output of a laser is schematically depicted. According to the illustrated thermal differential system 400, the power output of the laser may be measured to more accurately determine the change in laser power output resulting from a change in temperature, e.g. the change in power resulting from a change in the population of excited molecules in the gain medium as well as the change in the cavity length resulting based on the coefficient of thermal expansion of the cavity, etc.

As shown in FIG. 5, the temperature differential system 400 may generally include a thermally conductive member 402, such as a strip or plate of aluminum. A beam 404 from the laser may be incident on a portion of the thermally conductive member 402. In one embodiment, the beam 404 from the laser may be provided as loss in the laser output beam path, for example, a reflective loss from the beam combiner of the laser system. In one such embodiment in which the beam combiner is being used to combine a guide beam with the output beam of the laser, slight amounts of laser light may be lost from the combiner. The thermally conductive member 402 may be positioned so that at least some of the lost light is incident on the thermally conductive member 402. In other embodiments, the beam 404 may result from the antireflective coating of the beam combiner producing detectable amounts of light from the laser output beam.

A first temperature sensor 406 may be positioned to sense the temperature of the thermally conductive member 402 adjacent the beam 404. A second temperature sensor 408 may be positioned spaced from the first temperature sensor 406 and adjacent a heat sink 410, which is in thermal communication with the thermally conductive member 402. Accordingly, the second temperature sensor 408 may sense the temperature of the conductive member 402 adjacent the heat sink 410. The energy input from the beam 404 and the heat removal provided by the heat sink 410 may create a temperature gradient between the first temperature sensor 406 and the second temperature sensor 408.

An output from each of the first temperature sensor 406 and the second temperature sensor 408 may be arranged to provide a differential signal. For example, an output from the first temperature sensor 406 and from the second temperature sensor 408 may be provided to a differential amplifier 412, providing an output 414 representative of the laser power output. In some embodiments, correction factors, for example determined based on laser characteristics and/or comparison between the output 414 and another direct measurement of the laser output power, may be applied to the output 414 to provide a direct indication of the laser output power, although this is not necessary.

The output 414, either with or without the application of correction factors, may be supplied to the laser system to provide a correction of the laser output power consistent with any of the foregoing embodiments or combinations thereof. That is, the differential output 414 may be fed back to the laser host system 10 to provide an adjustment of the PWM control signal 18 in order to compensate for the change in laser power output. Consistent with other embodiments, the differential output signal 414 may be fed back to the laser controller 14 to provide an adjustment of the RF power 20 to the laser tube 16 in order to compensate for a detected change in laser power output. In one such embodiment, adjustment of the RF power 20 to the laser tube 16 may be accomplished by controlling the DC power 17 supplied to the RF power amplifier 15. In another embodiment, the RF power 20 to the laser tube 16 may be adjusted by controlling the bias on an FET 19 of the RF power amplifier 15.

Consistent with the disclosure herein, a laser output power may be adjusted to compensate for a change in laser output power resulting from a change in the temperature of the laser tube. Compensation for the change in laser output power may be carried out based on a sensed temperature of the laser tube, a cooling medium, ambient temperature, etc. Additionally or alternatively, compensation for the change in laser output power may be carried out based on a direct measurement of the laser output power.

The preceding disclosure has generally referred to providing an increased driving power to a laser tube in order to compensate for a loss in performance associated with an increase in the temperature of the laser tube. Utilizing this system it may be possible to provide a generally uniform or stable laser power output over temperature. From a broader standpoint, however, the temperature compensation system according to the present disclosure may adjust a power input to generally offset any increase or decrease in power resulting from temperature change.

While the embodiments have been described in the context of an RF carbon dioxide laser, the laser temperature compensation system of the present disclosure may be suitably used with other carbon dioxide lasers, such as a DC excited carbon dioxide laser. Additionally, the laser temperature compensation system may also suitably be used with other gas and non-gas lasers.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

1. A method, comprising:
measuring a temperature of a CO2 laser tube;
generating a feedback signal indicative of the temperature of said CO2 laser tube; and
adjusting a power supplied to said CO2 laser tube based on, at least in part, said feedback signal.

2. The method of claim 1, wherein said adjusting further comprising:
changing a duty cycle of a PWM signal, said PWM signal controlling power supplied to said CO2 laser tube.

3. The method of claim 1, wherein said adjusting further comprising:
changing a DC power supply to adjust an RF (radio frequency) power amplifier, said RF power supply supplying power to said CO2 laser tube.

4. The method of claim 1, wherein said adjusting further comprising:
biasing a power FET (field effect transistor) comprised in an RF (radio frequency) power amplifier, using said feedback signal, to adjust an RF power supplied to said laser tube.

5. The method of claim 1, further comprising:
measuring a temperature of a cooling medium associated with the laser tube or ambient air;
generating a second feedback signal indicative of the temperature of said cooling medium or said ambient air; and
adjusting a power supplied to said laser tube based on, at least in part, said feedback signal and said second feedback signal.

6. An apparatus, comprising:
a CO2 laser tube;
a temperature sensor coupled to said CO2 laser tube and capable of measuring a temperature of said CO2 laser tube and generating a feedback signal indicative of the temperature of said CO2 laser tube; and
a power supply capable of supplying an RF (radio frequency) power to said CO2 laser tube, said power supply is further capable of adjusting said RF power supplied to said CO2 laser tube based on, at least in part, said feedback signal.

7. The apparatus of claim 6, wherein said power supply comprising a host system capable of generating a PWM signal controlling power supplied to said CO2 laser tube, said host system is capable of changing a duty cycle of said PWM signal based on, at least in part, said feedback signal.

8. The apparatus of claim 6, wherein said power supply comprising an RF power amplifier and a DC power supply, said DC power supply is capable of adjusting a DC power supplied to said RF power amplifier based on, at least in part, said feedback signal.

9. The apparatus of claim 6, wherein said wherein said power supply comprising a power FET (field effect transistor) capable of generating said RF power supply, said feedback signal is capable of biasing said power FET to adjust an RF power supplied to said laser tube.

10. The apparatus of claim 6, further comprising:
a second temperature sensor capable of measuring a temperature of a cooling medium associated with the laser tube or ambient air and generating a second feedback signal indicative of the temperature of said cooling medium or said ambient air; and wherein
said power supply is further capable of adjusting said RF power supplied to said laser tube based on, at least in part, said feedback signal and said second feedback signal.
